(19) United States
(12) Patent Application Publication
(10) Pub. No.: US 2016/0019557 A1
(43) Pub. Date: Jan. 21, 2016

(54) SYSTEMS, METHODS, AND APPARATUS FOR PROVIDING MACHINE-TO-MACHINE AND CONSUMER-TO-MACHINE INTERACTION APPLICATION PLATFORMS

(71) Applicants: Alok Batra, Sunnyvale, CA (US); Jane Ren, Sunnyvale, CA (US)

(72) Inventors: Alok Batra, Sunnyvale, CA (US); Jane Ren, Sunnyvale, CA (US)

(21) Appl. No.: 14/692,505

(22) Filed: Apr. 21, 2015

Related U.S. Application Data
(60) Provisional application No. 61/982,151, filed on Apr. 21, 2014.
(60) Provisional application No. 61/982,155, filed on Apr. 21, 2014.

(51) Int. Cl. G06Q 30/02; G06F 3/0484

(52) U.S. Cl. CPC G06Q 30/0201; G06F 3/0484

(57) ABSTRACT

Systems, methods, and computer readable media for facilitating machine-to-machine communication and consumer-to-machine communications are disclosed. Systems include a distributed interstitial platform configured to provide one or more application programming interfaces for the creation of first and second “inverse facing” applications. The platform may allow for receiving of instructions, such as from an end user, at the first application. The platform may allow for the instructions to be processed by a machine integrated with the second application. These instructions may thus be used to operate the machine or device. The distributed interstitial platform may then track the use of first and second created applications for revenue generation.

### PRIORITY

The present application claims priority to U.S. Provisional Application 61/982,155, filed Apr. 21, 2014.

The present application claims priority to U.S. Provisional Application 61/982,151, filed Apr. 21, 2014.

### FIELD OF THE INVENTION

The present invention relates to machine-to-machine communications. In particular, the present invention relates to an interstitial platform for machine-to-machine and consumer-to-machine communications.

### BACKGROUND OF THE INVENTION

While some machine-to-machine (M2M) solutions can be relatively simple, with a single application operating upon data from a single type of device over one type of communications system, solutions become far more complex as devices and a myriad of device types proliferate through the world in the age of the Internet of Things (IoT). In such instances, strict application of normalization engines, as known in the art, in which the “language” spoken by the machine on each side of an M2M equation, becomes impractical. Further, advanced M2M (and consumer to machine, or C2M) solutions may have multiple services on the edge node, several different connectivity requirements, various data consumers, and geographically diverse services and devices. Therefore, it may be advantageous to have an intermediary system, rather than a normalization system, such to connect machines and M2M environments seamlessly to business applications and C2M environments.

### SUMMARY OF THE INVENTION

Systems, methods, and computer readable media for facilitating machine-to-machine and consumer-to-machine environments and communications are disclosed. Systems include a distributed interstitial platform configured to provide one or more application programming interfaces (API) for the creation of first and second “inverse facing” applications respectively. The platform may receive instructions via a first API, such as for generation of applications, or “apps,” intended for an end user. The platform may provide uniform integration points from those first apps developed via that first API to allow for integration with second, “inverse facing” apps (i.e., machine facing apps), developed via the second API. Accordingly, processing and data performed by a machine associated with a second app may be seamlessly provided to either a first app, or another second app related to a different machine, without need of normalization. Thereby, the first app may be used to interoperate and/or obtain data from a machine associated with the second app.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 illustrates a system of machines offering limiting machine-to-machine capability;

FIG. 2 illustrates potential benefits of embodiments of the present disclosure;

FIG. 3 is an illustration of a system according to embodiments of the present disclosure;

FIG. 4 is an illustration of a system according to embodiments of the present disclosure;

FIG. 5 is an illustration of an ecosystem illustrating the interaction of platform components according to embodiments of the present disclosure;

FIG. 6 illustrates various revenue streams according to embodiments of the present disclosure; and

FIG. 7 is an illustration of a widget and project lifecycle according to embodiments of the present disclosure;

### DETAILED DESCRIPTION OF THE EMBODIMENTS

It is to be understood that the figures and descriptions of the present invention have been simplified to illustrate elements that are relevant for a clear understanding of the present invention, while eliminating, for the purpose of clarity, many other elements found in typical similar systems, processes, and materials. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Embodiments of the present disclosure facilitate the creation of widgets and apps. Widgets may take the form of stand-alone apps which may be embedded into other apps. Widgets may be used to construct portions of apps which may interact with one or more machines in enterprise environments, and/or with one or more users.

Apps may be used in conjunction with one or more devices. For example, an app may be able to monitor behavior of a device or machine, thus increasing enterprise device awareness. The app may configure devices with rules to, at least in part, align devices with potential business processes and decisions. Further, apps may serve to connect a device to other devices or machines, such as to monitor or control, which may streamline business processes. Also, apps may be used to control apps and/or widgets associated with or integrated with machines or the behaviors thereof. More specifically, the apps may automate business processes or improve business outcomes.

Apps may be useful in providing insight to many environments including but not limited to industrial machines, healthcare equipment and devices, scientific instruments, and manufacturing equipment. As an example of its applicability to healthcare, a centralized medical equipment state monitoring and configuration app may allow biomedical engineers to increase operating room uptime with lower costs. As another example, an app may send data across medical equipment's based on a physician's preference or instruction. This may allow physicians to treat more patients in a given time.

Embodiments of the present disclosure are directed to a platform which may provide for systems and/or enable methods for building and deploying the aforementioned apps and widgets. In short, apps may allow end users the ability to monitor, control, connect, and connect to various machines having associated therewith apps/widgets interconnective to the user apps, such as based upon common API integration points.

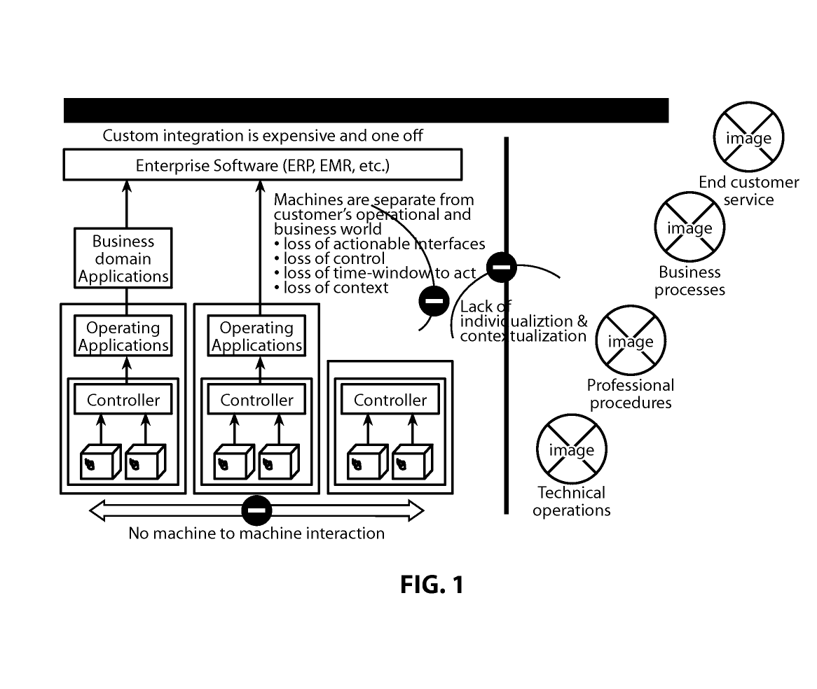

FIG. 1 illustrates a system of machines offering limiting machine-to-machine capability. Traditionally, machine-to-machine environments have consisted of piecemeal technologies wrangled together from disparate vendors that do not, for the most part, and absent significant normalization intermediary efforts, communicate or learn from each other. As such, machines, even machines having common purpose but of different types, are essentially siloed. Further, machines are separate from human user's operational and business world, which is largely mobile and is frequently thus based on portable devices and apps resident thereon. This separation may lead to loss of actionable interfaces, loss of control, loss of time to act, loss of context, and the like. Historically, any integration across machines and between machines and between machines and users requires high levels of customization and normalization, which can be prohibitively expensive, and which typically provides only a “droplet in the ocean solution”—that is, the customization and normalization provides interoperability only for the particular machines for which the customization and normalization is performed. As such, embodiments of the present disclosure employ a distributed and programmable interstitial platform designed to act as an intermediary system for the development and offering of connections between machine processes, users, and business processes for orchestration of machine to machine interactions. Further, embodiments may enable quick development time for apps driven by end users and interactive with machines.

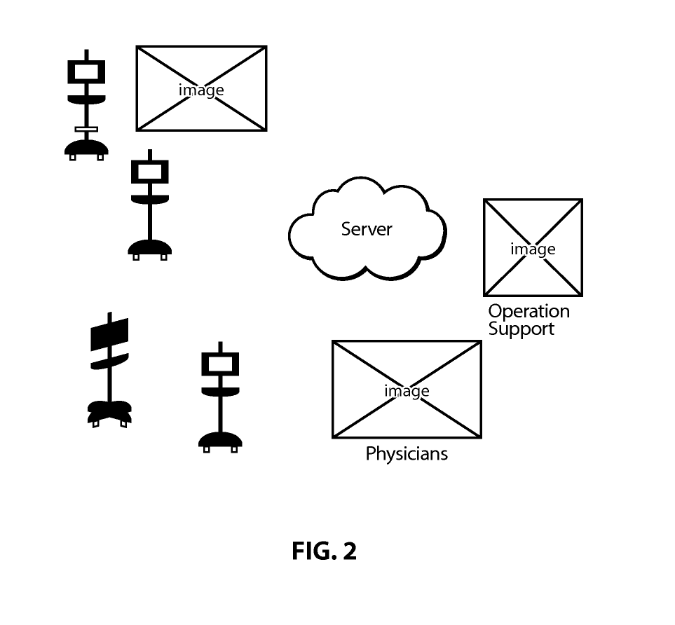

FIG. 2 illustrates embodiments of the present disclosure. A typical scenario may require an operator to perform daily test calls of machines at site, such as to ensure the machines are operating properly. If the operator encounters any issues, he or she may call IT on site with instructions to remedy the issue. In the unfortunate event the issue is not resolved, the operator may need to travel to the site to troubleshoot. This extra time spent fixing an issue may cause, for example, physicians (who regularly depend on the proper operation of these machines) frustration due to this downtime. As such, embodiments of the disclosure may increase uptime, performance, and physician user satisfaction by, at least in part, allowing users, such as physicians, and other operators the ability to quickly monitor key parameters of all systems, regardless of the vendor. If there is any issue with a machine, instead of the operator constantly having to perform daily diagnostic tests, an alert may be automatically generated to notify the operator, and/or a troubleshooting user app may allow for direct insight into the machines' operation by accessing the “machine-facing” app for that machine.

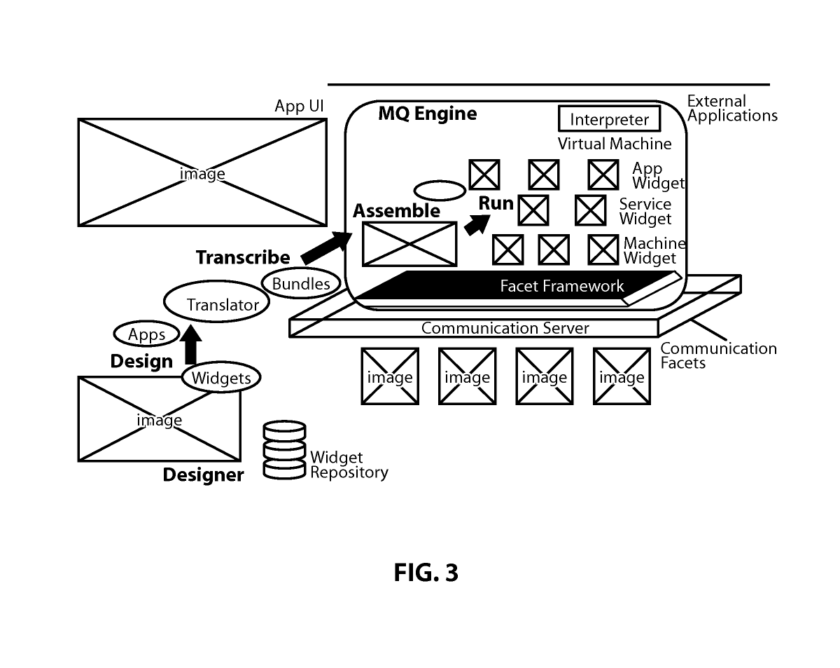

FIG. 3 is an illustration of the system according to embodiments of the present disclosure. As shown, embodiments are directed to an interstitial platform that provides one or more application programming interfaces (APIs) to allow for the creation of apps and widgets to be “inverse facing”, i.e., to be “user facing” and “machine facing”. Embodiments are thus directed to an integrated platform that establishes multiple entry points, and that provides common integration points for apps and widgets designed within the platform.

Developers (e.g., designers) may develop widgets that are able to run on the interstitial platform. The widgets may be created in part through use of a repository of existing widgets, which may be used in the development of apps. According to embodiments of the present disclosure, the interstitial platform may take the form of a software layer for use in interworking for a data exchange, and the like, between applications, applications and widgets, or between an application and a network for providing the services of identification, authentication, security, control, multimedia, and the like, related to devices thereon, based upon common integration points for all apps/widgets developed using a common API or set of inverse-facing APIs. As such, when a network connects to an application or applications directly connect to each other, common codes are present that allow for all common API set developed applications to communicate not only with network devices, but also with other apps, having common integration point coding . . . interstitial platform. Accordingly, the interstitial platform supports interworking between a network and each app, and between apps/widgets.

The interstitial platform (i.e., engine) may, for example, communicate with a wide range of devices through an optional communication server. The engine may host various services which use the devices that communicate with the engine. The services may include custom services implemented and hosted in the engine for end users or other third parties.

Communication between apps/widgets, and thus as well with the end users may be facilitated through a network. The network may be any type of computer or telecommunications network, such as the Internet, the cellular network, or a dedicated or private network. The devices may include any types of devices/sensors/apparatus/systems/machines which may communicate with the engine such as cellular phones, pagers, automobile engine control units, tire pressure monitoring system, health care monitoring systems, security systems, video cameras, photographic cameras, or other devices.

The platform may thus allow developers to create apps that are able to run on a dedicated platform, or on any platform to which the interstitial platform may be integrated and/or interconnected. “User facing” apps may contain user interfaces allowing various end users to control, monitor, and configure desired machines through the use of machine facing apps or widgets. For example, through the use of a declarative software language, the platform allows for interoperability of the app with the machine through the machine facing app, which may be created by a manufacturer or other developer, via the same API as is created the user app, or via a different API having a commonality of integration points with the API used to develop the user app. Through this connectivity, the end user has a seamless experience of working with various machines through the use of the user interface app.

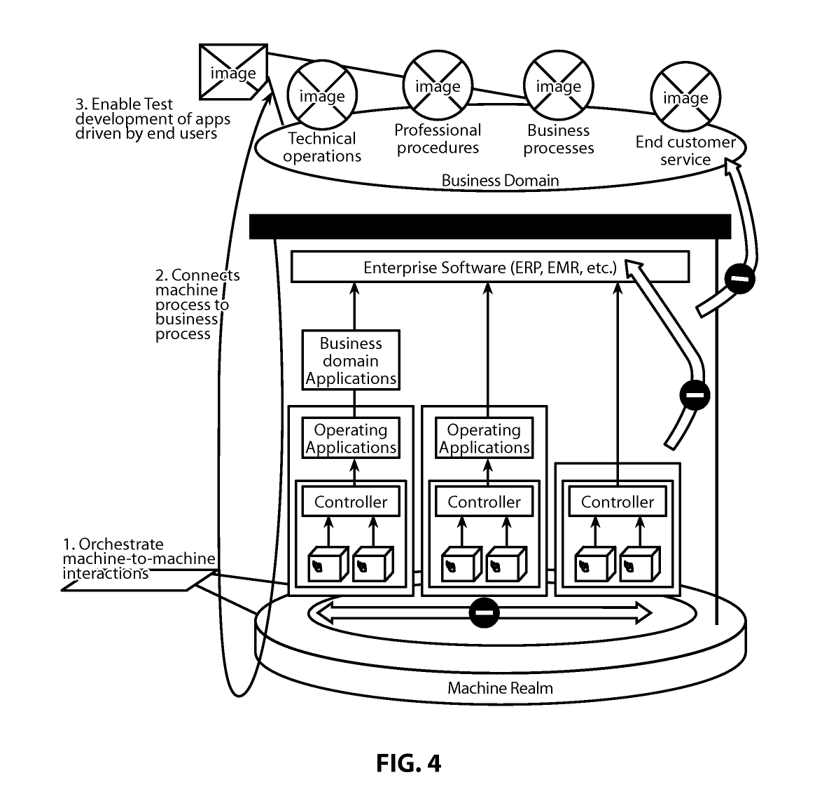

In light of the above disclosure, and as shown in FIG. 4, embodiments of the present disclosure allow for the orchestration of machine-to-machine interactions, the connection of machine processes to business processes, and quick development and deployment of apps driven by end users.

As discussed above, embodiments of the present disclosure also allow for the quick development and deployment of apps to interact with various machines. These apps may be of various types including but not limited to: service-enabling apps, sales-enabling apps, research and development enabling apps, operator-centric apps, professional centric apps, and executive-centric apps.

Service enabling apps may allow machines to be serviced proactively, thus increasing efficiency. This type of app may enable the remote monitoring, maintenance, or upgrade of the machines.

Sales enabling apps may empower a sales force with machine information, knowledge and timely customer interactions. For example, these apps may automate consumable sales based on machine data from machine apps, or may connect customers in real time to sales support personnel from a machine that is currently being operated, or from an app then-associated with that machine being operated.

Research and development enabling apps may facilitate research and development of new/innovative products & services through customer interactions to direct the research, development, prototyping, etc. For example, machine apps running on installed-to machines allow for experimentation with new features as well as track reactions, such as customer reactions to these new features via a user app. Apps may also collect and analyze customer's machine interaction patterns and use the insight for new product development.

Operator-centric apps may also run on machines themselves to ensure the machines operate properly. These apps can provide real time information, alerts, and simple processes and control mechanisms to simplify an operator's tasks and augment their value. For example, an operator-centric app may send an operator alerts whenever certain parameter (e.g., temperature) of any of the machines at the factory exceed a given limit.

Professional-centric apps may be geared towards professionals, such as doctors, pilots, and scientists. More particularly, these apps allow professionals to remotely read lab equipment data output, for example, and reconfigure the equipment, at any time, day or night.

Executive-centric apps may facilitate business decisions regarding machines such as capital investments, or business decisions based on machine-derived intelligence. For example, these apps may act across multiple machines, often at a fleet or system level, and can provide relevant information and interactions to create executive level value.

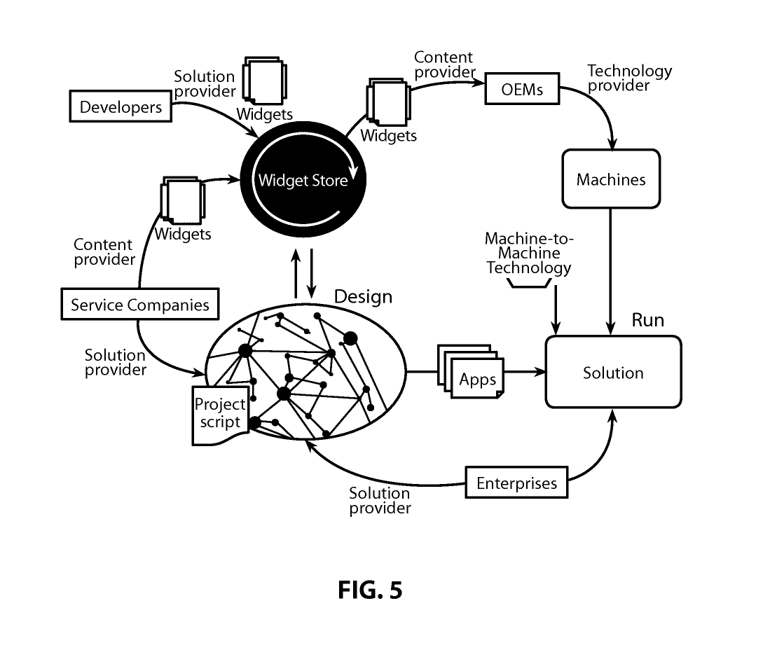

Embodiments of the disclosure are directed to the generation of revenue based on the use of the interstitial platform discussed hereinthroughout. For example, and as illustrated in the ecosystem interactions of FIG. 5, through the use of platform components, such as design time studios (allowing for the creation of apps and widgets) and run-time components, revenue can be realized. To do so, several different platform roles may be contemplated. These roles include, but are not limited to a solution provider, content provider, technology provider, and customer. The solution provider may create and deliver projects and apps; buy and use third party content; and/or buy and use third party technology. The content provider may create content (e.g., widgets and app templates), publish content, and sell or license the content to others. The technology provider may provide machines, sensors or other machine-to-machine technologies, either directly to the customer or to the service provider. Lastly, the customer may own the apps, being the main beneficiary of the solution.

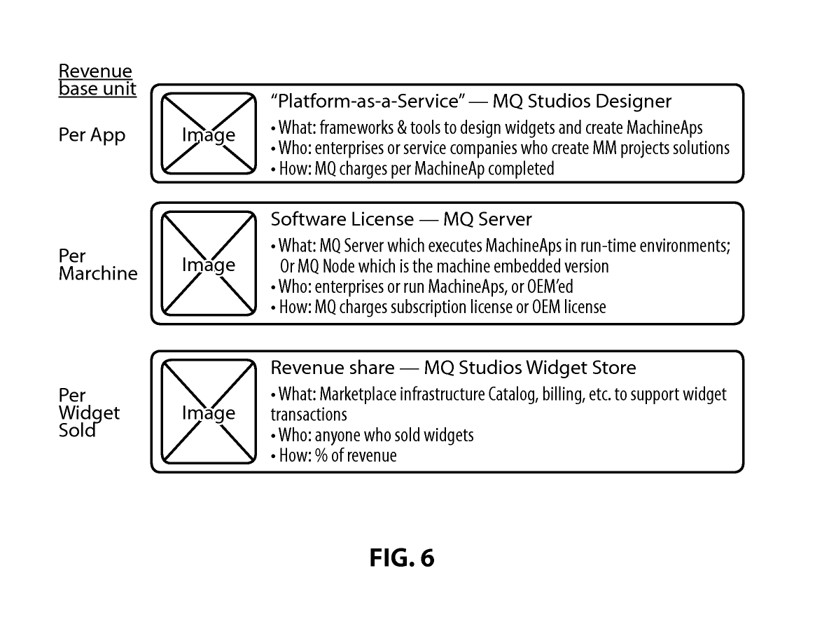

As illustrated in FIG. 6, embodiments of the present disclosure contemplate various revenue streams including platform-as-a-service (PaaS), software licensing, and an “app store” model. In the PaaS model, the designer may create the software and tools to create the apps, using the tools from the interstitial platform. Revenue may be generated based on the number of apps created.

As discussed hereinthroughout, embodiments of the present disclosure decompose complex machine-to-machine systems into individual units of widgets (e.g., machine widgets) that can be sold and bought independently. Because of the capabilities of the Domain Extensible Language (DEL), widgets that are written by different developers/designers can plug-and-play with each other. For example, one widget can be used (or reused) in different environments and within different running systems and/or solutions. These, among other, properties give independent economic value to the widgets themselves, which can become commodities to be bought and sold. That is, the economic value of the systems and solutions can now be distributed to each individual widget that makes up the system.

Widgets also have value, at least because they are capable of running on the interstitial platform. Written in the same set of DELs, the platform executes the workflow described by the widgets. At design time, a widget is only DEL-based description, as opposed to general computer readable code. Only after the transaction is it combined with the interstitial platform (engine) to create an executable widget. Therefore, without the platform, the widget may not have much value. As such, this mechanism gives the business model the ability to tie the widgets and the platform together, and benefit from the network effect. That is, the more widgets sold, the more demand on the platform. Thus, the more adoption of the platform, the higher the value of the widgets.

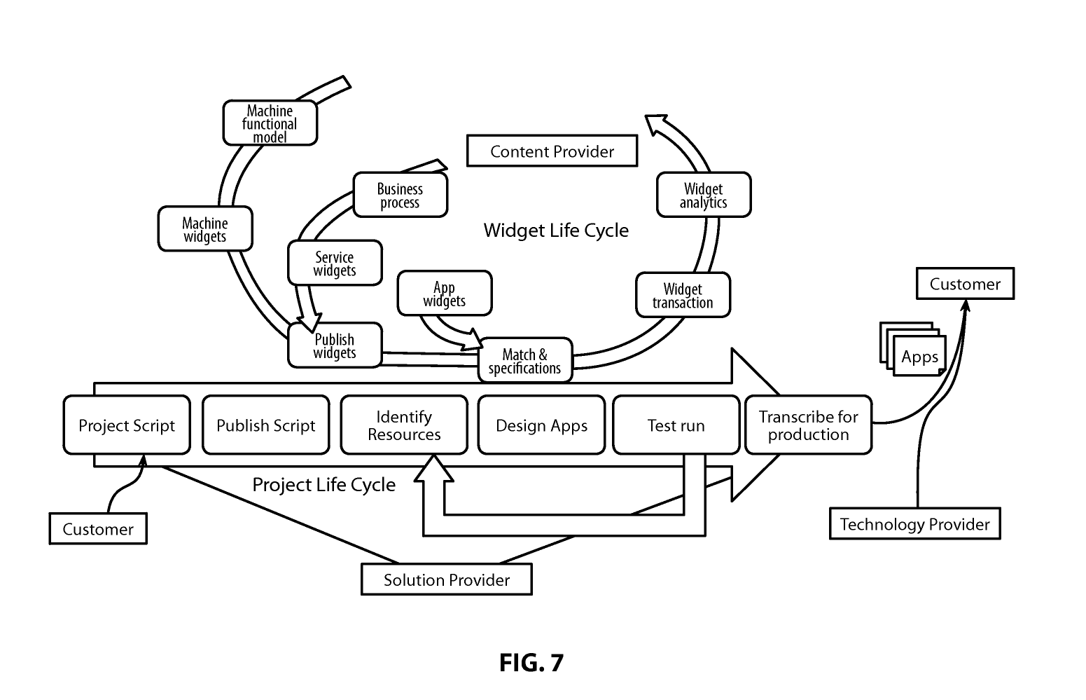

Referring now to FIG. 7, embodiments of the present disclosure also provide a management system and environment (e.g., widget life cycle and project life cycle) in which not only transactions of widgets, but also collaborations can occur using widgets to build larger systems. As can be seen in FIG. 7, project collaboration promotes widget transactions, and widget transactions facilitate projects.

Further, embodiments may also employ crowdsourcing. For example, when the lifecycles are defined and supported, multiple parties may participate in the completion of a machine-to-machine project, with multiple contributors of multiple components. The solution provider (the party that delivers the overall project) can choose which widget from the appropriate content provider to use.

Also, embodiments of the present disclosure define and manage different roles from which the creation and exchange/transaction of widgets can happen within an ecosystem, as described above. With respect to software licensing, the platform may execute apps in run time environments. Enterprises that run the apps may be charged a subscription license or OEM license. Alternatively, a widget store may take the form of a marketplace to support widget transactions. As such, revenue may be generated based on the number of widgets sold out of the widget store.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in software, wherein the functions may be stored on or transmitted over as one or more instructions or code on a computer-readable medium, and preferably on a non-transitory computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is rather to be accorded the widest scope consistent with the principles and novel features disclosed herein.

1. A method for facilitating machine-to-machine (M2M) and consumer-to-machine (C2M) communications and workflows, the method comprising:
providing a first Domain Extensible Language (DEL) to allow for the creation of a first widget for interfacing with a user;
providing a second DEL to allow for the creation of a second widget for interfacing with a machine, wherein the first DEL and the second DEL share a commonality of integration points;
providing a third DEL to allow for the creation of a third widget for carrying out a workflow, wherein the third widgets has shared integration points through DELs with the first and the second widget to relay instructions;
packaging the three widgets into an app and deploy on the interstitial platform; and
receiving instructions to the first widget from the user via a user interface;
providing the received instructions through the integration points for processing by the third widget, to carry out the workflow; and
instructing, through the integration points between the third widget and the second widget, the second widget to implement interactions with the machine based on the processed instructions, and
tracking the use of the interstitial platform and the use of the first second, and third created widgets for revenue generation.

2. The method of claim 1, wherein the tracking includes tracking customer reactions to the app.

3. The method of claim 1, wherein the platform comprises at least one role and the role is selected from the group consisting of: a solution provider, a content provider, a technology provider, and a customer.

4. The method of claim 1, wherein further widgets can communicate with the widgets, wherein the further widgets are written in DEL.

5. The method of claim 1, wherein the platform executes the app in a run time environment.

6. The method of claim 1, further comprising a widget store.

7. The method of claim 6, wherein revenue generation is further based on the number of widgets sold by the widget store.

8. The method of claim 7, wherein widgets become executable widgets once combined with the platform.

9. The method of claim 1, wherein the platform supports user collaboration.

10. The method of claim 9, wherein the user collaboration employs crowdsourcing.

11. A system comprising a hardware processor and a memory for facilitating machine-to-machine (M2M) and consumer-to-machine (C2M) communications and workflows, the system configured to:
provide a first Domain Extensible Language (DEL) to allow for the creation of a first widget for interfacing with a user;
provide a second DEL to allow for the creation of a second widget for interfacing with a machine, wherein the first DEL and the second DEL share a commonality of integration points;
provide a third DEL to allow for the creation of a third widget for carrying out a workflow, wherein the third widgets has shared integration points through DELs with the first and the second widget to relay instructions;
package the three widgets into an app and deploy on the interstitial platform; and
receive instructions at the first widget from the user via a user interface;
provide the received instructions through the integration points for processing by the third widget, to carry out the workflow; and
instruct, through the integration points between the third widget and the second widget, the second widget to implement interactions with the machine based on the processed instructions, and
track the use of the interstitial platform and the use of the first second, and third created widgets for revenue generation.

12. The system of claim 11, wherein the tracking includes tracking customer reactions to the app.

13. The system of claim 11, wherein the platform comprises at least one role and the role is selected from the group consisting of: a solution provider, a content provider, a technology provider, and a customer.

14. The system of claim 11, wherein further widgets can communicate with the widgets, wherein the further widgets are written in DEL.

15. The system of claim 11, wherein the platform executes the app in a run time environment.

16. The system of claim 11, further comprising a widget store.

17. The system of claim 16, wherein revenue generation is further based on the number of widgets sold by the widget store.

18. The system of claim 17, wherein widgets become executable widgets once combined with the platform.

19. The system of claim 11, wherein the platform supports user collaboration.

20. The system of claim 19, wherein the user collaboration employs crowdsourcing.
